(19) United States
(12) Patent Application Publication
(10) Pub. No.: US 2014/0082671 A1
(43) Pub. Date: Mar. 20, 2014

(54) METHOD AND DEVICE FOR SMART SELECTION OF TV CHANNELS

(71) Applicant: Quatius Limited, Hong Kong (CN)

(72) Inventor: Ka Wing Cheung, Hong Kong (CN)

(21) Appl. No.: 13/907,221

(22) Filed: May 31, 2013

(30) Foreign Application Priority Data
Sep. 14, 2012 (CN) 201210343861.0

(51) Int. Cl. H04N 21/482

(52) U.S. Cl. CPC H04N 21/4826
USPC 725/46

(57) ABSTRACT

A method for smart selection of TV channels is disclosed. The method includes the following steps: receiving a first user command, obtaining the current time, and determining a preset time period based on the current time, and prompting a first list of recommended channels corresponding to the preset time period; the first list of recommended channels is determined by the following steps: obtaining the accumulated broadcasting duration of each channel by accumulating the historical broadcasting duration of each channel during the preset time period; ranking the channels according to their accumulated broadcasting duration, the channel with longer broadcasting duration being ranked in front of the channel with shorter broadcasting duration, based on which the first list of recommended channels is determined. A corresponding device is further provided. The device includes an acquisition module and a prompting module.

### FIELD OF THE INVENTION

The present invention relates to the field of TV channel-controlling, and more particularly to a method and device for smart selection of TV channels.

### BACKGROUND OF THE INVENTION

In a traditional television, the function of “interchanging between two channels” and the function of “listing favorite programs” are provided. The function of “interchanging between two channels” allows the user to switch the channel to the last watched channel, and the function of “listing favorite programs” allows the user to set his favorite channels. Apart from this, the user must rely on memory to remember the numbers of channels or to select channels one by one.

The function of “list of favorite programs” allows the user to add into or delete from the list his favorite programs, while the programs list is a static list which shall not automatically be adjusted with the time or following the watching behavior of the user. Meanwhile, setting his favorite program channels by the user himself would often result in the changes of the program channels due to changes of the program contents. Besides, the numbers of favorite program channels are often limited; when there are many family members or their own favorite program channels are different in different time periods, the need of all family members to set their own list of favorite programs can hardly be met. Adding favorite program channels into the list is never adopted, for it will make the list too long.

Therefore, heretofore unaddressed needs exist in the art to address the aforementioned deficiencies and inadequacies.

### SUMMARY OF THE INVENTION

It is an object of the present invention to provide a method and device for smart selection of TV channels, which is able to adjust the favorite programs automatically, thereby solving the problem that the user' s favorite programs vary in different time periods.

According to an aspect of the invention, a method for smart selection of TV channels includes the following steps:

receiving a first user command, obtaining current time, determining a preset time period based on the current time, and prompting a first list of recommended channels corresponding to the preset time period;

determining the first list of recommended channels includes: obtaining the accumulated broadcasting duration of each channel by accumulating the historical broadcasting duration of each channel during the preset time period; ranking the channels according to their accumulated broadcasting duration, the channel with longer accumulated broadcasting duration is ranked in front of the channel with shorter broadcasting duration, based on which the first list of recommended channels is determined.

By the above method for smart selection of TV channels, the broadcasting duration is divided into different time periods, and the broadcasting duration of each channel in different time periods are accumulated and ranked to obtain the first list of recommended channels. By this way, the favorite programs can be adjusted automatically, solving the problem of different favorite programs in different time periods.

According to another aspect of the invention, a device for smart selection of TV channels includes:

an acquisition module, configured to obtain the current time according to the first user command and to determine the preset time period based on the current time;

a prompting module, configured to prompt the first list of recommended channels corresponding to the preset time period based on the first user command; the first list of recommended channels is determined by steps including: obtaining the accumulated broadcasting duration of each channel by accumulating the historical broadcasting duration of each channel during the preset time period; ranking the channels according to their accumulated broadcasting duration, the channel with longer accumulated broadcasting duration is ranked in front of the channel with shorter accumulated broadcasting duration, based on which the first list of recommended channels is determined.

With the above device for smart selection of TV channels, the broadcasting duration is divided into different time periods, and the broadcasting duration of each channel in different time periods are accumulated and ranked, obtaining the first list of recommended channels. By this way, the favorite programs can be adjusted automatically, solving the problem of different favorite programs in different time periods.

### BRIEF DESCRIPTION OF THE DRAWINGS

FIG. 1 is a flow chart of a method for smart selection of TV channels according to one embodiment of the present invention.

FIG. 2 is a flow chart of a method for smart selection of TV channels according to one embodiment of the present invention.

FIG. 3 is a flow chart of a method for smart selection of TV channels according to one embodiment of the present invention.

FIG. 4 is a flow chart of a method for smart selection of TV channels according to one embodiment of the present invention.

FIG. 5 is a flow chart of a method for smart selection of TV channels according to one embodiment of the present invention.

FIG. 6 is a structural schematic diagram of the device for smart selection of TV channels according to one embodiment of the present invention.

FIG. 7 is a structural schematic diagram of the device for smart selection of TV channels according to one embodiment of the present invention.

FIG. 8 is a structural schematic diagram of the device for smart selection of TV channels according to one embodiment of the present invention.

FIG. 9 is a structural schematic diagram of the device for smart selection of TV channels according to one embodiment of the present invention.

FIG. 10 is a structural schematic diagram of the device for smart selection of TV channels according to one embodiment of the present invention.

### DETAILED DESCRIPTION OF THE EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

### Embodiment 1

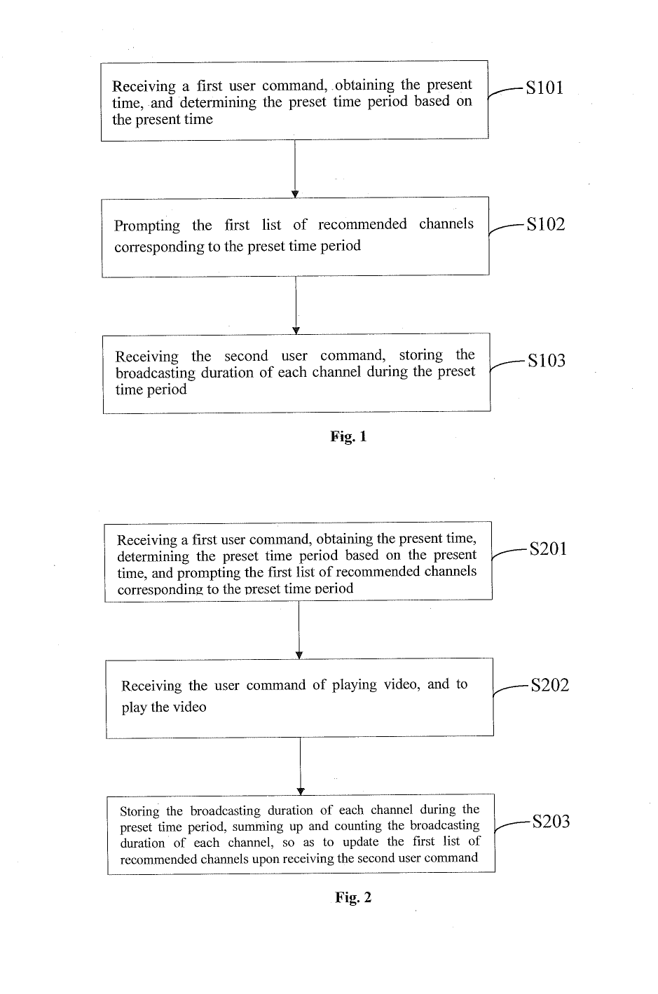

FIG. 1 is a flow chart of a method for smart selection of TV channels according to the first embodiment of the present invention. The method includes the following steps.

Step S101: receive a first user command, obtain the current time, and determine the preset time period based on the current time.

S102: prompt the first list of recommended channels corresponding to the preset time period. The ways to determine the first list of recommended channels includes: obtaining the total broadcasting duration of each channel by accumulating the historical broadcasting duration of each channel during the preset time period; ranking the channels according to their accumulated broadcasting duration, and the channel with longer accumulated broadcasting duration is ranked in front of the channel with shorter broadcasting duration, based on which the first list of recommended channels is determined.

S103: receive a second user command, and store the broadcasting duration of each channel during the preset time period.

The first user command may be a user turn-on command, a user channel-selecting command and a user checking command, while the second user command may be a user channel-switching command, a user turn-off command or a user presetting command. The user presetting command is a command provided according to the user's need. For example, the second user command is set to 10:00 pm, and then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these ways.

For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, so the time periods are combined into one.

For instance, upon receiving a first turn-on command, the TV is switched on in the second time period of 06:00-9:00, then the first list of recommended channels for the time period of 06:00-9:00 is prompted.

The first list of recommended channels is obtained by accumulating the accumulated historical broadcasting duration of each channel during the time period of 06:00-9:00, and ranking the channels according to their accumulated broadcasting duration. For instance, on Monday CCTV channel is broadcasted for 45 minutes, and Guangdong TV channel for 15 minutes; on Tuesday CCTV channel is broadcasted for 55 minutes, and CETV channel for 70 minutes. Thus, the accumulated broadcasting duration of each channel is that: 100 minutes for CCTV channel, 15 minutes for Guangdong TV channel and 70 minutes for CETV channel.

The total historical broadcasting duration of each channel can be summed periodically according to the preset broadcasting duration. The preset time period may be one week, one month or a quarter of the year, which depends on the specific situation. For instance, the broadcasting duration of each channel may be obtained once a month and reset after one month, and then the next calculation starts again, by storing the broadcasting duration of each channel, to obtain the total broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked according to their accumulated broadcasting duration, the channel with longer accumulated broadcasting duration being ranked in front of the channel with shorter accumulated broadcasting duration, based on which the first list of recommended channels is determined. For instance, the ranking may be that: CCTV channel, CETV channel, Guangdong TV channel. The amount of channels in the first recommended list is set upon different need, such as 5, 10 and 17, etc., by which the first list of recommended channels is obtained.

By prompting the first list of recommended channels, it means that the first list of recommended channels can be displayed directly, or can be notified by voice, or in other ways. The user can get a general knowledge of the historical watched programs, facilitating the user in selecting channels.

When receiving the second command, such as a turn-off command, the storage module 603 stores the length of duration of each channel during 06:00-9:00.

### Embodiment 2

In the second embodiment, when receiving the first user command such as a turn-on command or a channel-selecting command, the first list of recommended channels of the preset time period that has been determined last time is prompted. When the second user command such as a turn-off command or a channel-selecting command is received, the length of duration is stored, accumulated and ranked, thus updating the first list of recommended channels.

FIG. 2 is a flow chart of a method for smart selection of TV channels according to the second embodiment of the present invention. The method includes the following steps.

Step S201: receive a first user command, obtain the current time, and determine the preset time period based on the current time, and prompt the first list of recommended channels corresponding to the preset time period.

Step S202: receive the user command of playing to play the video.

Step S203: when the second user command is received, store the broadcasting duration of each channel during the preset time period, and accumulate the broadcasting duration of each channel and the historical broadcasting duration of each channel during the preset time period, so as to obtain the total broadcasting duration of each channel; rank the channels according to their accumulated broadcasting duration, and the channel with longer accumulated broadcasting duration is ranked in front of the channel with shorter accumulated broadcasting duration, by which the first list of recommended channels is updated.

The first user command may be a user turn-on command, a user channel-selecting command and a user checking command, while the second user command may be a user channel-switching command, a user turn-off command or a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment described will adopt one of these ways.

For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may be for children, and the fifth time period may be for a husband. On non-working days, everyone rests, so the time periods are combined into one.

When the user turns on the TV, the current time is obtained, based on which the preset time period is determined, such as the second time period of 06:00-9:00. The first list of recommended channels that has been stored, accumulated and ranked in the last preset time period is retrieved and prompted. The first list of recommended channels can be displayed directly, or can be notified by voice. If it is the first time to use the function, the first list of recommended channels shall be prompted as null.

When a channel-switching command is received, the broadcasting duration of the channel during this time period is stored, and the broadcasting duration of the channel watched before switching together with its historical broadcasting duration during this time period are accumulated, obtaining the accumulated broadcasting duration of this channel. For instance, it is CCTV channel that was broadcasted before switching the channel, and when switching the channel, the broadcasting duration of CCTV is stored and accumulated with the historical broadcasting duration of CCTV in the time period of 06:00-9:00, and thus the accumulated broadcasting duration of CCTV is obtained.

The accumulated historical broadcasting duration of each channel can be accumulated periodically according to the preset broadcasting duration. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked according to their accumulated broadcasting duration, the channel with longer accumulated broadcasting duration being in front of the channel with shorter accumulated broadcasting duration, based on which the updated first list of recommended channels is obtained. The amount of channels in the first recommended list is set upon different need, such as 5, 10 and 17, etc.

When the channel-selecting command is received, the current time is obtained, based on which the preset time period is determined. The first list of recommended channels that has been obtained by storing, accumulating and ranking the broadcasting duration of each channel during this preset time period is retrieved and prompted.

When a turn-off command is received, similar to the channel-selecting command, the broadcasting duration of the channel before switching during this preset time period together with its historical broadcasting duration during this time period are accumulated, obtaining the accumulated broadcasting duration of this channel. By this way the first list of recommended channels are obtained.

In a similar way, it can be configured that the broadcasting duration of each channel is stored only when a turn-off command is received; and the broadcasting duration of each channel watched this time together with its historical broadcasting duration during this time period are accumulated, obtaining the accumulated broadcasting duration of each channel; and then, the channels are ranked according to their accumulated broadcasting duration, and the channel with longer accumulated broadcasting duration is in front of the channel with shorter broadcasting duration, by which the first list of recommended channels is updated. As a result, when the user selects channels or turns on the TV, the first list of recommended channels prompted can only be the previous first list of recommended channels of the preset time period. For instance, when the TV is turned on during the time period of 06:00-9:00, the first list of recommended channels prompted is NULL, and the user may select different channels. When the user is selecting channels, the first list of recommended channels prompted is NULL. When the TV is turned off, the broadcasting duration of each channel is stored, and respectively accumulated with their historical broadcasting duration (which is zero at present) and ranked, by which the No. 1 first list of recommended channels is obtained. In the next day, when the TV is turned on during the time period of 06:00-9:00, the No. 1 first list of recommended channels is prompted. The user may select channels based on that No. 1 first list of recommended channels and play video. When the user is switching channel, no action will be taken. When the user is selecting channels, the No. 1 first list of recommended channels is prompted. And at last, when the TV is turned off, the broadcasting duration of each channel is stored, and respectively accumulated with their historical broadcasting duration and ranked, by which the No. 2 first list of recommended channels is obtained. The other technical features are same to the above method.

### Embodiment 3

In the third embodiment, when a first user command such as a turn-on command or a channel-selecting command is received, the user may choose to prompt the first list of recommended channels or the second list of recommended channels, and thus the first list of recommended channels or the second list of recommended channels is prompted directly. When receiving the second user command such as a turn-off command or a channel-switching command, the broadcasting duration and number of times of broadcasting are stored, accumulated and ranked, thus updating the first list of recommended channels and the second list of recommended channels.

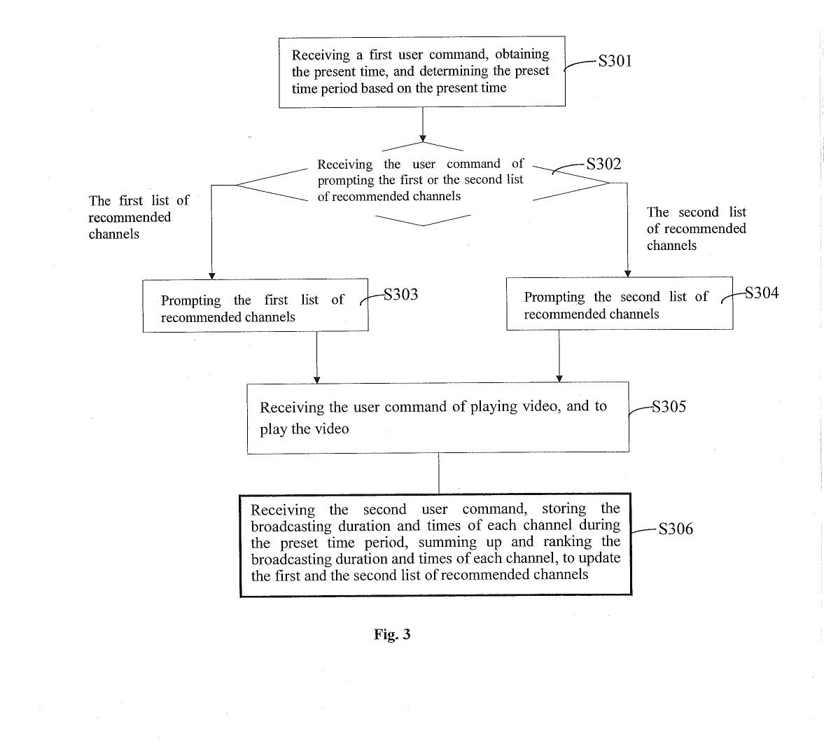

FIG. 3 is a flow chart a method for smart selection of TV channels according to the third embodiment of the present invention. The method includes the following steps:

Step S301: receiving a first user command, obtaining the current time, and determining the preset time period based on the current time;

Step S302: receiving the user command of prompting the first list of recommended channels or the second list of recommended channels; when the command of prompting the first list of recommended channels is received, go to Step S303, and when the command of prompting the second list of recommended channels is received, go to Step S304;

Step S303: prompting the first list of recommended channels and going to Step S305;

Step S304: prompting the second list of recommended channels and going to Step S305;

Step 305: receiving the user command for playing video, and thus play the video;

Step S306: when receiving the second user command, storing the broadcasting duration and number of times of broadcasting of each channel during the preset time period.

The broadcasting duration of each channel and the historical broadcasting duration of each channel during the preset time period are accumulated, so as to obtain the accumulated broadcasting duration of each channel; the channels are then ranked according to their accumulated broadcasting duration, the channel with longer duration is ranked in front of the channel with shorter duration, by which the first list of recommended channels is updated.

The number of times of broadcasting of each channel and the historical number of times of broadcasting of each channel during the preset time period are accumulated, so as to obtain the accumulated number of times of broadcasting of each channel; the channels are then ranked according to their accumulated number of times of broadcasting, and the channel with more number of times of broadcasting is ranked in front of the channel with less number of times of broadcasting, by which the second list of recommended channels is updated.

The first user command may be a user turn-on command, a user channel-selecting command and a user checking command, while the second user command may include a user channel-switching command, a user turn-off command and a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, so the time periods are combined into one.

When the user turns on the TV, the current time is obtained, based on which the preset time period is determined, such as the second time period of 06:00-9:00. The user can choose whether to prompt the first list of recommended channels or to prompt the second list of recommended channels. When the first list of recommended channels is chosen, the first list of recommended channels that has been stored, accumulated and ranked in the last preset time period is retrieved and prompted. When the second list of recommended channels is chosen, the second list of recommended channels that has been stored, accumulated and ranked in the last preset time period is retrieved and prompted. The first list of recommended channels can be displayed directly, or can be notified by voice. If it is the first time to use the function, the first list of recommended channels shall be prompted as null. The second list of recommended channels chosen to be prompted will be illustrated as an example in the following description.

When a channel-switching command is received, the broadcasting duration of the channel during this time period is stored, and the broadcasting duration of the channel watched before switching together with its historical broadcasting duration during this time period are accumulated, obtaining the accumulated broadcasting duration of this channel. For instance, it is CCTV channel that has been broadcasted before switching the channel; when switching channels, the broadcasting duration of CCTV is stored, and accumulated with the historical broadcasting duration of CCTV in the time period of 06:00-9:00, and thus the accumulated broadcasting duration of CCTV is obtained.

The historical number of times of broadcasting of each channel can be accumulated periodically according to the preset period. The preset time period can be one week, one month or a quarter of the year, which depends on the specific situation. For instance, the number of times of broadcasting of each channel may be obtained once a month and reset after one month, and then the next calculation starts again, by storing the number of times of broadcasting of each channel, to obtain the accumulated number of times of broadcasting of each channel. That is, the historical number of times of broadcasting to be accumulated is within the preset time period, which may be one week, one month or a quarter of the year, depending on the specific situation. For instance, the number of times of broadcasting of each channel may be obtained once a month, and when one month has passed, the number of times of broadcasting stored one month ago shall be cleared and new number of times of broadcasting within the last one month is added, according to the principle of “first in, first out”.

Channels are ranked according to their accumulated number of times of broadcasting, channel with more accumulated number of times of broadcasting is ranked in front of the channel with less number of times of broadcasting, based on which the updated second list of recommended channels is obtained. The amount of channels in the second recommended list is set upon different need, such as 5, 10 and 17, etc.

When the channel-selecting command is received, the current time is obtained, based on which the preset time period is determined; and the second list of recommended channels that has been obtained by storing, accumulating and ranking the number of times of broadcasting of each channel during this preset time period is retrieved and prompted.

When a turn-off command is received, similar to the channel-selecting command, the number of times of broadcasting of the channel before switching during this preset time period is accumulated together with its historical number of times of broadcasting during this time period, obtaining the accumulated number of times of broadcasting of this channel. By this way the second list of recommended channels are obtained.

In an embodiment, the method further includes the step of: when turning on the TV or selecting channels, the user can choose whether to prompt the first list of recommended channels or to prompt the second list of recommended channels. If the answer is yes, then the page shows the first list of recommended channels or the second list of recommended channels, and the user may select channels according to the first list of recommended channels or the second list of recommended channels.

In an embodiment, the method further includes the step of: when turning on the TV or selecting channels, the user can choose whether to prompt the list of favorite channels. The list of favorite channels is set by the user himself based on the user's preference. If the answer is yes, then the list of favorite channels is prompted.

There is no fixed sequence in choosing whether to prompt the first list of recommended channels, the second list of recommended channels or the list of favorite channels, and can be set by the user himself based on the user's preference. The first list of recommended channels, the second list of recommended channels and the list of favorite channels can be displayed directly, or can be notified by voice to the user.

In an embodiment, the method further includes the step of: the user can set locked channels, such as some obscene channels, which can be locked by the user. The broadcasting duration and times of these channels will not be stored.

In an embodiment, the method further includes the step of: when watching a program, the user can choose whether to store the broadcasting duration and times of each channel, and if the user chooses not to store, then the broadcasting duration of each channel will not be stored.

In a similar way, it can be configured that the broadcasting duration of each channel is stored only when a turn-off command is received; and the broadcasting duration of each channel watched this time is accumulated together with its historical broadcasting duration during this time period, obtaining the accumulated broadcasting duration of each channel; and then, the channels are ranked according to their accumulated broadcasting duration, the channel with longer accumulated broadcasting duration is ranked in front of the channel with shorter accumulated broadcasting duration, by which the first list of recommended channels is updated. As a result, when selecting channels or turning on the TV, the first list of recommended channels prompted can only be the previous first list of recommended channels of the preset time period. For instance, when the TV is turned on during the time period of 06:00-9:00, the first list of recommended channels prompted is NULL, and the user selects different channels to watch. When the user is selecting channels, the first list of recommended channels prompted is NULL. When the TV is turned off, the broadcasting duration of each channel is stored, and respectively accumulated with their historical broadcasting duration (which is zero at present) and ranked, by which the first list of recommended channels is obtained. In the next day, when the TV is turned on during the time period of 06:00-9:00, the first list of recommended channels is prompted. The user can select channels based on that first list of recommended channels and play video. When the user is switching channel, no action will be taken. When the user is selecting channels, the first list of recommended channels is prompted. And at last, when the TV is turned off, the broadcasting duration of each channel is stored, and respectively accumulated with their historical broadcasting duration and ranked, by which the first list of recommended channels is obtained. The other technical features are same to the above method. The way of prompting the second list of recommended channels is similar to that of the first list of recommended channels.

### Embodiment 4

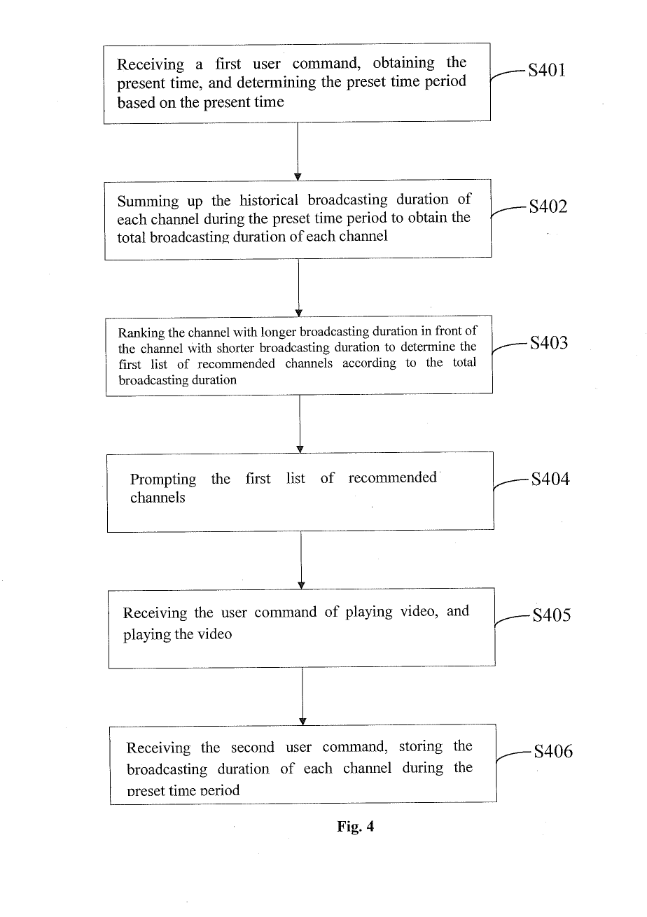

In the fourth embodiment, when a first user command such as a turn-on command or channel-selecting command is received, the first list of recommended channels is determined by storing, accumulating and ranking the historical broadcasting duration of each channel during this preset time period, and is then prompted. When a second user command such as a turn-off command is received, the broadcasting duration is stored. FIG. 4 is a flow chart of the method for smart selection of TV channels according to the fourth embodiment of the present invention. The method includes the following steps.

Step S401: receive a first user command, obtain the current time, and determine the preset time period based on the current time.

Step S402: obtain the accumulated broadcasting duration of each channel by accumulating the historical broadcasting duration of each channel during the preset time period.

Step S403: rank the channels according to their accumulated broadcasting duration, the channel with longer accumulated broadcasting duration is ranked in front of the channel with shorter broadcasting duration, based on which the first list of recommended channels is determined.

Step S404: prompt the first list of recommended channels.

Step S405: receive a user command of play video, and play the video.

Step S406: when receive the second user command, store the broadcasting duration of the channel during the preset time period.

The first user command may be a user turn-on command, a user channel-selecting command and a user checking command, while the second user command may include a user channel-switching command, a user turn-off command and a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these examples. For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, thus the time periods are combined into one.

When the user turns on the TV, the current time is obtained, based on which the preset time period is determined, such as the second time period of 06:00-9:00. The historical broadcasting duration of each channel during the historical time period of 06:00-9:00 are accumulated to get the accumulated broadcasting duration of each channel. For instance, before the TV is turned on, during the time period of 06:00-9:00, on Monday CCTV channel is broadcasted for 45 minutes, and Guangdong TV channel for 15 minutes; on Tuesday CCTV channel is broadcasted for 55 minutes, and CETV channel for 70 minutes. Thus, the accumulated broadcasting duration of each channel is that: 100 minutes for CCTV channel, 15 minutes for Guangdong TV channel and 70 minutes for CETV channel.

The accumulated historical broadcasting duration of each channel can be summed periodically according to the preset broadcasting duration. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked according to their accumulated broadcasting duration, channel with longer accumulated broadcasting duration being the first of the list is ranked in front of the channel with shorter accumulated broadcasting duration, based on which the updated first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted, wherein the first list of recommended channels can be displayed directly, or can be notified by voice.

When a channel-switching command is received, the broadcasting duration of the channel watched before switching channel is stored in the record of the time period of 06:00-9:00.

When the command of channel-selecting is received, the current time is obtained, based on which the preset time period is determined, such as the second time period of 06:00-9:00. The historical broadcasting duration of each channel during the historical time period of 06:00-9:00 are accumulated to get the accumulated broadcasting duration of each channel. For instance, before selecting channels, during the time period of 06:00-9:00, on Monday CCTV channel is broadcasted for 45 minutes, with Guangdong TV channel for 15 minutes; on Tuesday CCTV channel is broadcasted for 55 minutes, with CETV channel for 70 minutes; on Wednesday CCTV channel is broadcasted for 25 minutes, with CETV channel for 30 minutes. Thus, the accumulated broadcasting duration of each channel is that: 125 minutes for CCTV channel, 15 minutes for Guangdong TV channel and 100 minutes for CETV channel Channels are ranked according to their accumulated broadcasting duration, the channel with longer accumulated broadcasting duration is ranked in front of the channel with shorter accumulated broadcasting duration, based on which the updated first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted.

When a turn-off command is received, similar to the channel-selecting command, the broadcasting duration of the channel watched before turn-off the TV is stored in the record of the time period of 06:00-9:00.

In a similar way, it can be configured that the broadcasting duration of each channel is stored only when a turn-off command is received. Therefore, when selecting channels or turning on the TV, the first list of recommended channels prompted can only be the first list of recommended channels of last time period. For the above example, CCTV channel has been broadcasted for 25 minutes on Wednesday and CETV for 30 minutes; the broadcasting duration this time will not be stored until the TV is turned off. Therefore, when a user selects channels after having watched the two programs, the first list of recommended channels prompted is the same with the first list of recommended channels being prompted in turning-on the TV. The first list of recommended channels will only be changed until the TV is turned on next time. The other technical features are the same with the above method.

### Embodiment 5

In the fifth embodiment, when a first user command is received such as the turn-on command or channel-selecting command, the first list of recommended channels and the second list of recommended channels are determined by storing, accumulating and ranking the historical broadcasting duration and times of each channel. The user then chooses to prompt the first list of recommended channels or the second list of recommended channels to prompt the list of recommended channels. When the second user command is received such as the turn-off command or the switching-channel command, the broadcasting duration and times are stored.

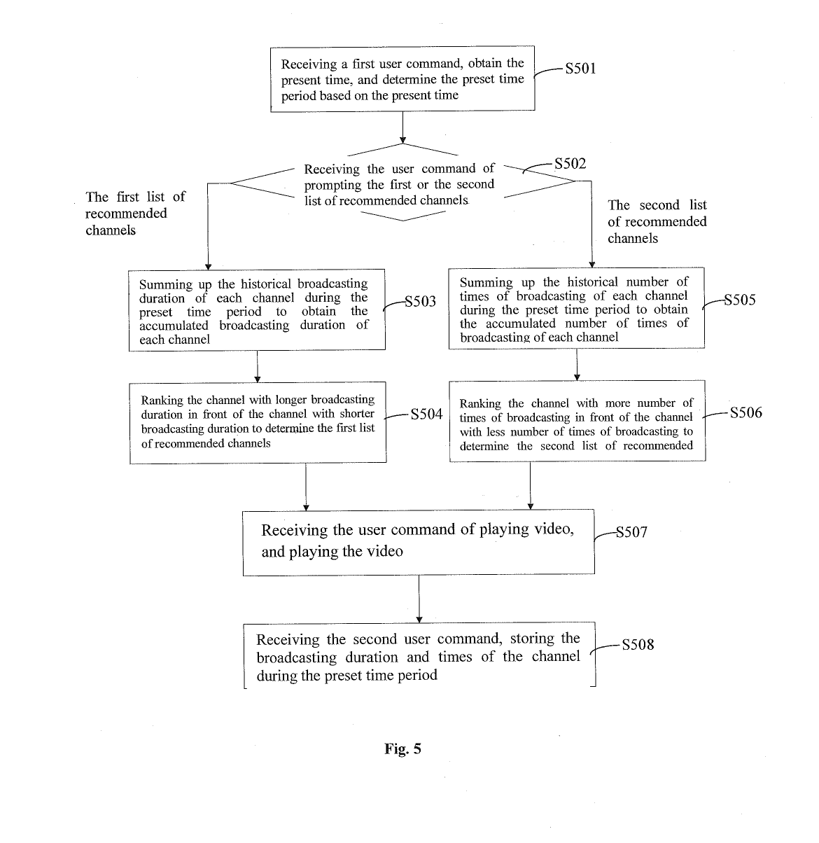

FIG. 5 is a flow chart of a method for smart selection of TV channels according to the fifth embodiment of the present invention. The method includes the following steps.

Step S501: receive a first user command, obtain the current time, and determine the preset time period based on the current time.

Step S502: receive the user command of prompting the first list of recommended channels or the second list of recommended channels; when the command of prompting the first list of recommended channels is received, go to Step S503, and when the command of prompting the second list of recommended channels is received, go to Step S505.

Step S503: obtain the accumulated broadcasting duration of each channel by accumulating the historical broadcasting duration of each channel during the preset time period.

Step S504: rank the channels according to their accumulated broadcasting duration, the channel with longer accumulated broadcasting duration is ranked in front of the channel with shorter accumulated broadcasting duration, based on which the first list of recommended channels is determined; then go to Step S507.

Step S505: obtain the accumulated broadcasting duration of each channel by accumulating the historical broadcasting duration of each channel during the preset time period.

Step S506: rank the channels according to the accumulated number of times of broadcasting of each channel, the channel with more number of times of broadcasting is ranked in front of the channel with less number of times of broadcasting, based on which the second list of recommended channels is determined.

Step S507: receive the user command of play, so as to play the video.

Step S508: when receive the second user command, store the broadcasting duration and times of each channel during the preset time period.

The first user command may be a user turn-on command, a user channel-selecting command and a user checking command, while the second user command may include a user channel-switching command, a user turn-off command and a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these examples. For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, so the time periods are combined into one.

When the user turns on the TV, the current time is obtained, based on which the preset time period is determined, such as the second time period of 06:00-9:00. The user can choose whether to prompt the first list of recommended channels or to prompt the second list of recommended channels. When the first list of recommended channels is chosen, the accumulated broadcasting duration of each channel is obtained by accumulating the historical broadcasting duration of each channel during the preset time period; rank the channels according to their accumulated broadcasting duration, and the channel with the longer accumulated broadcasting duration is ranked in front of the channel with shorter accumulated broadcasting duration, based on which the first list of recommended channels is determined. Based on the determined first list of recommended channels, the first list of recommended channels is prompted. When the second list of recommended channels is chosen, the accumulated number of times of broadcasting of each channel is obtained by accumulating the historical number of times of broadcasting of each channel during the preset time period; ranking the channels according to the accumulated number of times of broadcasting of each channel, the channel with more number of times of broadcasting is ranked in front of the channel with less number of times of broadcasting, based on which the second list of recommended channels is determined. Based on the determined second list of recommended channels, the second list of recommended channels is prompted. The second list of recommended channels can be displayed directly, or can be notified by voice. The second list of recommended channels chosen to be prompted will be illustrated as an example in the following description.

The accumulated number of times of broadcasting of each channel is obtained by accumulating the historical number of times of broadcasting of each channel during the historical time period of 06:00-9:00. For instance, before the TV is turned on, during the time period of 06:00-9:00, on Monday CCTV channel has been broadcasted for three times, with Guangdong TV channel for two times; on Tuesday CCTV channel has been broadcasted for three times, with CETV channel for four times. Thus, the accumulated number of times of broadcasting of each channel is that: six times for CCTV channel, two times for Guangdong TV channel and four times for CETV channel.

The historical number of times of broadcasting of each channel can be summed periodically according to the preset broadcasting duration. The preset time period can be one week, one month or a quarter of the year, which depends on the specific situation. For instance, the number of times of broadcasting of each channel may be obtained once a month and reset after one month, and then the next calculation starts again to obtain the accumulated number of times of broadcasting of each channel. That is, the number of times of broadcasting to be accumulated is within the preset time period, which may be one week, one month or a quarter of the year, depending on the specific situation. For instance, the number of times of broadcasting of each channel may be obtained once a month, and when one month has passed, the number of times of broadcasting stored one month ago shall be cleared and new number of times of broadcasting within the last one month is added, according to the principle of “first in, first out”.

Channels are ranked according to the accumulated number of times of broadcasting, the channel with more number of times of broadcasting is ranked in front of the channel with less number of times of broadcasting, based on which the first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted. The first list of recommended channels can be displayed directly, or can be notified by voice.

When a channel-switching command is received, the number of times of broadcasting of the channel watched before switching channel is stored in the record of the time period of 06:00-9:00.

When the command of channel-selecting is received, the acquisition module 1001 will obtain the current time, based on which the preset time period is determined, such as the second time period of 06:00-9:00. The accumulated number of times of broadcasting of each channel is obtained via the counting module 1003 by accumulating the historical number of times of broadcasting of each channel during the historical time period of 06:00-9:00. For instance, before the TV is turned on, during the time period of 06:00-9:00, on Monday CCTV channel has been broadcasted for three times, with Guangdong TV channel for two times; on Tuesday CCTV channel has been broadcasted for three times, with CETV channel for four times. Thus, the accumulated number of times of broadcasting of each channel is that: six times for CCTV channel, two times for Guangdong TV channel and four times for CETV channel. The channels are ranked based on the accumulated number of times of broadcasting of each channel, the channel with more number of times of broadcasting is ranked in front of the channel with less number of times of broadcasting, based on which the updated second first list of recommended channels is determined. For instance, the ranking may be that: CCTV channel, CETV channel, Guangdong TV channel. The amount of channels in the first recommended list is set upon different need, such as 5, 10 and 17, etc. After that the first list of recommended channels is prompted. The first list of recommended channels can be displayed directly, or can be notified by voice.

When a turn-off command is received, similar to the channel-selecting command, the broadcasting duration of the channel before turn-off the TV is stored in the record of the time period of 06:00-9:00.

In an embodiment, the method further includes the step of: when turning on the TV or selecting channels, the user can choose whether to prompt the first list of recommended channels or to prompt the second list of recommended channels; if the answer is yes, then the page shows the first list of recommended channels or the second list of recommended channels, and the user can select channels according to the first list of recommended channels or the second list of recommended channels. If no command of prompting the first list of recommended channels or prompting the second list of recommended channels is received, then play video directly.

In an embodiment, the method further includes the step of: when turning on the TV or selecting channels, the user can choose whether to prompt the list of favorite channels. The list of favorite channels is set by the user himself based on the user's preference. If the answer is yes, then the list of favorite channels is prompted.

There is no fixed sequence in choosing to prompt the first list of recommended channels, the second list of recommended channels or the list of favorite channels, and can be set by the user himself based on the user's preference. The first list of recommended channels, the second list of recommended channels and the list of favorite channels can be displayed directly, or can be notified by voice to the user.

In an embodiment, the method further includes the step of: the user can set locked channels, such as some obscene channels, which can be locked by the user. The broadcasting duration and times of these channels will not be stored.

In an embodiment, the method further includes the step of: when watching a program, the user can choose whether to store the broadcasting duration and times of each channel; if the user chooses not to store, then the broadcasting duration of each channel will not be stored.

In a similar way, it can be configured that the number of times of broadcasting of each channel is stored only when a turn-off command is received. As a result, when selecting channels or turning-on the TV, the first list of recommended channels prompted can only be last time's first list of recommended channels of the preset time period. For the above example, CCTV channel has been broadcasted for two times on Wednesday, with CETV channel five times and Guangdong TV channel three times; the number of number of times of broadcasting this time will not be stored until the TV is turned off. Therefore, when selecting channels after having watched the two programs, the first list of recommended channels prompted is the same with the first list of recommended channels being prompted in turning-on the TV. The first list of recommended channels will only be changed until the TV is turned on next time. The other technical features are the same with the above method.

Based on the above method for smart selection of TV channels, a device for smart selection of TV channels is further provided.

### Embodiment 1

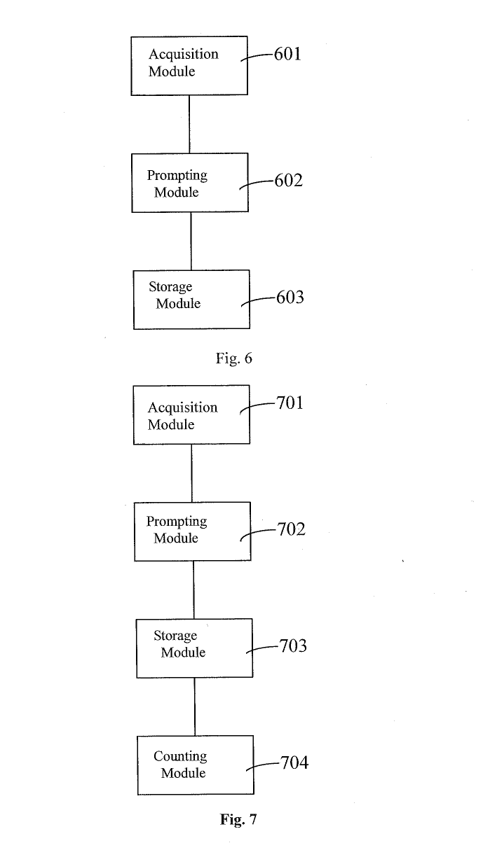

Referring to FIG. 6, which is the structural schematic diagram of the device for smart selection of TV channels according to the first embodiment of the present invention. The device includes:

an acquisition module 601, configured to obtain the current time upon the first user command, and to determine the preset time period based on the current time;

a prompting module 602, configured to prompt the first list of recommended channels which is in accordance to the preset time period upon receiving the first user command; the method for determining the first list of recommended channels includes: obtaining the accumulated broadcasting duration of each channel by accumulating the historical broadcasting duration of each channel during the preset time period; ranking the channels according to their accumulated broadcasting duration, the channel with longer accumulated broadcasting duration being ranked in front of the channel with shorter accumulated broadcasting duration, based on which the first list of recommended channels is determined;

a storage module 603, configured to store the broadcasting duration of each channel during the preset time period upon receiving the second user command.

The first user command may be a user turn-on command, a user channel-selecting command or a user checking command, while the second user command may be a user channel-switching command, a user turn-off command or a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. This embodiment will be described with one of these ways. For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, thus the time periods are combined into one.

For instance, upon receiving a first turn-on command, the acquisition module 601 obtains the second time period of 06:00-9:00, then the first list of recommended channels for the time period of 06:00-9:00 is prompted.

The first list of recommended channels is obtained by accumulating the accumulated historical broadcasting duration of each channel during the time period of 06:00-9:00, and ranking the channels according to their accumulated broadcasting duration, the channel with longer broadcasting duration is ranked in front of the channel with shorter broadcasting duration. For instance, on Monday CCTV channel is broadcasted for 45 minutes, and Guangdong TV channel for 15 minutes; on Tuesday CCTV channel is broadcasted for 55 minutes, and CETV channel for 70 minutes. Thus, the accumulated broadcasting duration of each channel is that: 100 minutes for CCTV channel, 15 minutes for Guangdong TV channel and 70 minutes for CETV channel.

The accumulated historical broadcasting duration of each channel can be summed periodically according to the preset broadcasting duration. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked according to their accumulated broadcasting duration, the channel with longer accumulated broadcasting duration is ranked in front of the channel with shorter accumulated broadcasting duration, based on which the first list of recommended channels is determined. For instance, the ranking may be that: CCTV channel, CETV channel, Guangdong TV channel. The amount of channels in the first recommended list is set upon different need, such as 5, 10 and 17, etc., by which the first list of recommended channels is obtained.

By prompting the first list of recommended channels, it means that the first list of recommended channels can be displayed directly, or can be notified by voice, or in other ways to be prompted. The user can get a general knowledge of the historical watched channels, facilitating the user in selecting channels.

When receiving the second command, such as turn-off command, the storage module 603 stores the length of duration of each channel during 06:00-9:00.

### Embodiment 2

In the second embodiment, when receiving the first user command such as a turn-on command or a channel-selecting command, the first list of recommended channels of the preset time period that has been determined last time is prompted. When receiving the second user command such as a turn-off command or a channel-selecting command, the length of duration is stored, accumulated and ranked, thus updating the first list of recommended channels.

FIG. 7 is a flow chart of the device for smart selection of TV channels according to the second embodiment of the present invention.

The device includes:

an acquisition module 701, configured to obtain the current time upon the first user command, and to determine the preset time period based on the current time;

a prompting module 702, configured to prompt the first list of recommended channels which is in accordance to the preset time period upon the first user command;

a storage module 703, configured to store the broadcasting duration of each channel during the preset time period upon the second user command;

a counting module 704, configured to sum up the broadcasting duration of each channel and the historical broadcasting duration of each channel during the preset time period, so as to obtain the accumulated broadcasting duration of each channel; ranking the channels according to their accumulated broadcasting duration, the channel with longer accumulated broadcasting duration is ranked in front of the channel with shorter accumulated broadcasting duration, by which the first list of recommended channels is updated.

The first user command may be a user turn-on command, a user channel-selecting command and a user checking command, while the second user command may be a user channel-switching command, a user turn-off command or a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these ways.

For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

Time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, thus the time periods are combined into one.

When the user turns on the TV, the acquisition module 701 obtains the current time, based on which the preset time period is determined, such as the second time period of 06:00-9:00; the first list of recommended channels that has been stored, accumulated and ranked in the last preset time period is retrieved and prompted by the prompting module 702, wherein the prompting module 702 can be a display module or a voice module, i.e. the first list of recommended channels can be displayed directly, or can be notified by voice. If it is the first time to use the function, the first list of recommended channels shall be prompted as null.

When a channel-switching command is received, the storage module 703 stores the broadcasting duration of the channel during this time period, and the counting module 704 sums up the broadcasting duration of the channel before switching together with its historical broadcasting duration during this time period, obtaining the accumulated broadcasting duration of this channel. For instance, it is CCTV channel that has been broadcasted before switching the channel; when switching the channel, the broadcasting duration of CCTV is stored, and accumulated with the historical broadcasting duration of CCTV in the time period of 06:00-9:00; thus the accumulated broadcasting duration of CCTV is obtained.

The accumulated historical broadcasting duration of each channel can be accumulated periodically according to the preset broadcasting duration by the counting model 704. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked by the counting module 704 according to their accumulated broadcasting duration, the channel with longer accumulated broadcasting duration is ranked in front of the channel with shorter accumulated broadcasting duration, based on which the updated first list of recommended channels is obtained. The amount of channels in the first recommended list is set upon different need, such as 5, 10 and 17, etc.

When the channel-selecting command is received, the acquisition module 701 will obtain the current time, based on which the preset time period is determined; the first list of recommended channels that has been obtained by storing, accumulating and ranking the broadcasting duration of each channel during this preset time period is retrieved and prompted by the prompting module 702.

When a turn-off command is received, similar to the channel-selecting command, the storage module 703 stores the broadcasting duration of the channel in the preset time period, and the counting module 704 sums up the broadcasting duration of channel play before switching with its historical broadcasting duration during this time period, obtaining the accumulated broadcasting duration of this channel. By this way the first list of recommended channels is obtained.

In a similar way, it can be configured that the broadcasting duration of each channel is stored by the storage module 703 only when a turn-off command is received; and the broadcasting duration of each channel watched this time together with its historical broadcasting duration during this time period are accumulated by the counting module 704, obtaining the accumulated broadcasting duration of each channel; and then, ranking the channels according to their accumulated broadcasting duration, the channel with longer accumulated broadcasting duration is ranked in front of the channel with shorter accumulated broadcasting duration, by which the first list of recommended channels is updated. As a result, when selecting channels or turning on the TV, the first list of recommended channels prompted by the prompting module 301 can only be the previous first list of recommended channels of the preset time period. For instance, when the TV is turned on during the time period of 06:00-9:00, the first list of recommended channels prompted is NULL, and the user selects different channels to watch. When the user is selecting channels, the first list of recommended channels prompted by the prompting module 301 is NULL. When the TV is turned off, the broadcasting duration of each channel is stored by the storage module 703, and respectively accumulated with their historical broadcasting duration (which is zero at present) and ranked by the counting module 704, in which the No. 1 first list of recommended channels is obtained. In the next day, when the TV is turned on during the time period of 06:00-9:00, the No. 1 first list of recommended channels is prompted by the prompting module 301. The user can select channels based on that No. 1 first list of recommended channels and play video. When the user is switching channel, no action will be taken. When the user is selecting channels, the No. 1 first list of recommended channels is prompted by the prompting module 301. And at last, when the TV is turned off, the broadcasting duration of each channel is stored by the storage module 703, and respectively accumulated with their historical broadcasting duration and ranked by the counting module 704, thus the No. 2 first list of recommended channels is obtained. The other technical features are same to the above method.

### Embodiment 3

In the third embodiment, when a first user command is received such as a turn-on command or a channel-selecting command, the user chooses to prompt the first list of recommended channels or the second list of recommended channels, and thus the first list of recommended channels or the second list of recommended channels is prompted directly. When receiving the second user command such as a turn-off command or a channel-switching command, the broadcasting duration and times are stored, accumulated and ranked, thus updating the first list of recommended channels and the second list of recommended channels.

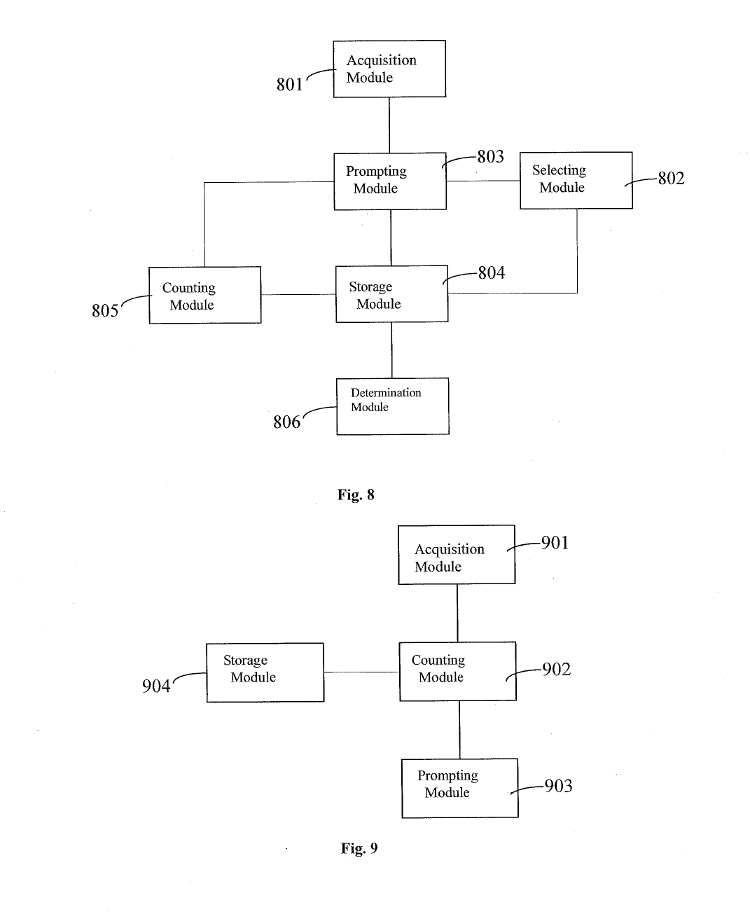

FIG. 8 is a flow chart of the device for smart selection of TV channels according to the third embodiment of the present invention.

The device includes:

an acquisition module 801, configured to obtain the current time upon the first user command, and to determine the preset time period based on the current time;

a selecting module 802, configured to send to the prompting module the command of prompting the first list of recommended channels upon receiving the user command of prompting the first list of recommended channels; or to send to the prompting module the command of prompting the second list of recommended channels upon receiving the user command of prompting the second list of recommended channels;

a prompting module 803, configured to receive the command of prompting the first list of recommended channels from the selecting module and to prompt the first list of recommended channels; or receiving the command of prompting the second list of recommended channels from the selecting module and to prompt the second list of recommended channels;

a storage module 804, configured to store the broadcasting duration and times of each channel during the preset time period in accordance to the second user command;

a counting module 805, configured to sum up the broadcasting duration of each channel and the historical broadcasting duration of each channel during the preset time period in accordance to the second user command, so as to obtain the accumulated broadcasting duration of each channel; and to rank the channels according to their accumulated broadcasting duration, the channel with longer accumulated broadcasting duration is ranked in front of the channel with shorter accumulated broadcasting duration, by which the first list of recommended channels is updated.

The storage module is further configured to sum up the number of times of broadcasting of each channel and the historical number of times of broadcasting of each channel during the preset time period in accordance to the second user command, so as to obtain the accumulated number of times of broadcasting of each channel; and to rank the channels according to their accumulated number of times of broadcasting, the channel with more number of times of broadcasting is ranked in front of the channel with less number of times of broadcasting, by which the second list of recommended channels is updated.

The first user command may be a user turn-on command, a user channel-selecting command and a user checking command, while the second user commands may be a user channel-switching command, a user turn-off command and a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these examples. For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, so the time periods are combined into one.

When the user turns on the TV, the current time is obtained, based on which the preset time period is determined, such as the second time period of 06:00-9:00. The user can choose whether to prompt the first list of recommended channels or to prompt the second list of recommended channels. When the first list of recommended channels is chosen, the selecting module 802 sends to the prompting module the command of prompting the first list of recommended channels, and the prompting module 803 retrieves and prompts the first list of recommended channels that has been stored, accumulated and ranked in the last preset time period. When the second list of recommended channels is chosen, the selecting module 802 sends to the prompting module the command of prompting the second list of recommended channels, and the prompting module 803 retrieves and prompts the second list of recommended channels that has been stored, accumulated and ranked in the last preset time period. The first list of recommended channels can be displayed directly, or can be notified by voice. If it is the first time to use the function, the first list of recommended channels shall be prompted as null. The second list of recommended channels chosen to be prompted will be illustrated as an example in the following description.

When a channel-switching command is received, the broadcasting duration of the channel during this time period is stored by the storage module 804, and the broadcasting duration of the channel before switching together with its historical broadcasting duration during this time period are accumulated by the counting module 805, obtaining the accumulated broadcasting duration of this channel. For instance, it is CCTV channel that has been broad casted before switching the channel; when switching channels, the broadcasting duration of CCTV is stored, and accumulated with the historical broadcasting duration of CCTV in the time period of 06:00-9:00; thus the accumulated broadcasting duration of CCTV is obtained.

The historical number of times of broadcasting of each channel can be accumulated periodically according to the preset time period by the counting model 805. The preset time period can be one week, one month or a quarter of the year, which depends on the specific situation. For instance, the number of times of broadcasting of each channel may be obtained once a month and reset after one month, and then the next calculation starts again, by storing the number of times of broadcasting of each channel, to obtain the accumulated number of times of broadcasting of each channel. That is, the historical number of times of broadcasting to be accumulated is within the preset time period, which may be one week, one month or a quarter of the year, depending on the specific situation. For instance, the number of times of broadcasting of each channel may be obtained once a month, and when one month has passed, the number of times of broadcasting stored one month ago shall be cleared and new number of times of broadcasting within the last one month is added, according to the principle of “first in, first out”.

Channels are ranked by the counting module 805 according to their accumulated number of times of broadcasting, the channel with more number of times of broadcasting is ranked in front of the channel with shorter accumulated number of times of broadcasting, based on which the updated second list of recommended channels is obtained. The amount of channels in the second recommended list is set upon different need, such as 5, 10 and 17, etc.

When the channel-selecting command is received, the current time is obtained by the acquisition module 801, based on which the preset time period is determined. The second list of recommended channels that has been obtained by storing, accumulating and ranking the number of times of broadcasting of each channel during this preset time period is retrieved and prompted by the prompting module 803.

When a turn-off command is received, similar to the channel-selecting command, the number of times of broadcasting of the channel before switching during this preset time period is accumulated together with its historical number of times of broadcasting during this time period, obtaining the accumulated number of times of broadcasting of this channel. By this way the second list of recommended channels are obtained, which will not be illustrate in detail.

In an embodiment, when turning on the TV or selecting channels, the selecting module 802 is also configured to allow the user to choose whether to prompt the first list of recommended channels or to prompt the second list of recommended channels. If the answer is yes, then the page shows the first list of recommended channels or the second list of recommended channels, and the user can select channels according to the first list of recommended channels or the second list of recommended channels.

In an embodiment, when turning on the TV or selecting channels, the selecting module 802 is also configured to allow the user to choose whether to prompt the list of favorite channels. The list of favorite channels is set by the user himself based on the user's preference. If the answer is yes, then the list of favorite channels is prompted.

There is no fixed sequence for the selecting module 802 to receive the commands of choosing to prompt the first list of recommended channels, the second list of recommended channels or the list of favorite channels, and can be set by the user himself based on the user's preference. The first list of recommended channels, the second list of recommended channels and the list of favorite channels can be displayed directly, or can be notified by voice to the user.

In an embodiment, the selecting module 802 is also configured to received the command of not storing the broadcasting duration or times of the channels, and to send to the storage module 804 the command of not storing the broadcasting duration or times of the channels; during the time of watching a program, the user can choose whether to store the broadcasting duration and times of each channel; if the user chooses not to store, then the broadcasting duration of each channel will not be stored.

In an embodiment, the device further includes a determination module 806, configured to determine whether there is any preset locked channel; if the answer is yes, then the determination module 806 sends to the storage module 804 the command of not storing the broadcasting duration or times of the locked channel. The user can set locked channels, such as some obscene channels, which can be locked by the user. The broadcasting duration and times of these channels will not be stored.

In a similar way, it can be configured that the broadcasting duration and times of each channel are stored by the storage module 804 only when a turn-off command is received; and the broadcasting duration and times of each channel watched this time together with its historical broadcasting duration and times during this time period are accumulated by the counting module 805, obtaining the accumulated broadcasting duration and times of each channel; and then the channels are ranked according to their accumulated broadcasting duration and times, the channel with longer accumulated broadcasting duration is ranked in front of the channel with shorter broadcasting duration, by which the first list of recommended channels is updated; the channel with more accumulated number of times of broadcasting is ranked in front of the channel with less accumulated number of times of broadcasting, by which the second list of recommended channels is updated. As a result, when selecting channels or turning on the TV, the first list of recommended channels prompted by the prompting module 803 can only be the previous first list of recommended channels of the preset time period. For instance, when the TV is turned on during the time period of 06:00-9:00, the first list of recommended channels prompted is NULL, and the user selects different channels. When the user is selecting channels, the first list of recommended channels prompted by the prompting module 803 is NULL. When the TV is turned off, the broadcasting duration of each channel is stored by the storage module 804, and respectively accumulated with their historical broadcasting duration (which is zero at present) and ranked by the counting module 805, by which the first list of recommended channels is obtained. In the next day, when the TV is turned on during the time period of 06:00-9:00, the first list of recommended channels is prompted by the prompting module 803. The user can select channels based on that first list of recommended channels and play video. When the user is switching channel, no action will be taken. When the user is selecting channels, the first list of recommended channels is prompted by the prompting module 803. And at last, when the TV is turned off, the broadcasting duration of each channel is stored by the storage module 804, and respectively accumulated with their historical broadcasting duration and ranked by the counting module 805, by which the first list of recommended channels is obtained. The other technical features are same to the above method.

### Embodiment 4

In the fourth embodiment, when a first user command is received such as the turn-on command or channel-selecting command, the first list of recommended channels is determined by storing, accumulating and ranking the historical broadcasting duration of each channel during this preset time period, and is then prompted. When a second user command is received such as the turn-off command, the broadcasting duration is stored.

FIG. 9 is the flow chart of the device for smart selection of TV channels according to the fourth embodiment of the present invention.

The device includes:

an acquisition module 901, configured to obtain the current time upon the first user command, and to determine the preset time period based on the current time;

a counting module 902, configured to sum up the broadcasting duration of each channel and the historical broadcasting duration of each channel during the preset time period, so as to obtain the accumulated broadcasting duration of each channel, and to rank the channels according to their accumulated broadcasting duration, the channel with longer accumulated broadcasting duration is ranked in front of the channel with shorter accumulated broadcasting duration, by which the first list of recommended channels is determined;

a prompting module 903, configured to prompt the first list of recommended channels corresponding to the preset time period upon receiving the first user command;

a storage module 904, configured to store the broadcasting duration of each channel during the preset time period upon receiving the second user command.

The first user command may be a user turn-on command, a user channel-selecting command and a user checking command, while the second user command may be a user channel-switching command, a user turn-off command or a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these ways.

For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, so the time periods are combined into one.

When the user turns on the TV, the current time is obtained by the acquisition module 901, based on which the preset time period is determined, such as the second time period of 06:00-9:00. The historical broadcasting duration of each channel during the historical time period of 06:00-9:00 are accumulated to get the accumulated broadcasting duration of each channel by the counting module 902. For instance, before the TV is turned on, during the time period of 06:00-9:00, on Monday CCTV channel is broadcasted for 45 minutes, with Guangdong TV channel for 15 minutes; on Tuesday CCTV channel is broadcasted for 55 minutes, with CETV channel for 70 minutes. Thus, the accumulated broadcasting duration of each channel is that: 100 minutes for CCTV channel, 15 minutes for Guangdong TV channel and 70 minutes for CETV channel.

The accumulated historical broadcasting duration of each channel can be accumulated periodically according to the preset broadcasting duration. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked according to their accumulated broadcasting duration by the counting module 902, the channel with longer accumulated broadcasting duration is ranked in front of the channel with shorter accumulated broadcasting duration, based on which the updated first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted by the prompting module 903, wherein the first list of recommended channels can be displayed directly, or can be notified by voice.

When a channel-switching command is received, the broadcasting duration of the channel before switching channel is stored by the storage module 904 in the record of the time period of 06:00-9:00.

When the command of channel-selecting is received, the acquisition module 901 will obtain the current time, based on which the preset time period is determined, such as the second time period of 06:00-9:00. The historical broadcasting duration of each channel during the historical time period of 06:00-9:00 are accumulated by the counting module 902 so as to obtain the accumulated broadcasting duration of each channel. For instance, before selecting channels, during the time period of 06:00-9:00, on Monday CCTV channel is broadcasted for 45 minutes, with Guangdong TV channel for 15 minutes; on Tuesday CCTV channel is broadcasted for 55 minutes, with CETV channel for 70 minutes; on Wednesday CCTV channel is broadcasted for 25 minutes, with CETV channel for 30 minutes. Thus, the accumulated broadcasting duration of each channel is that: 125 minutes for CCTV channel, 15 minutes for Guangdong TV channel and 100 minutes for CETV channel. Channels are ranked according to their accumulated broadcasting duration, the channel with longer accumulated broadcasting duration is ranked in front of the channel with shorter accumulated broadcasting duration, based on which the updated first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted by the prompting module 903, wherein the first list of recommended channels can be displayed directly, or can be notified by voice.

When a turn-off command is received, similar to the channel-selecting command, the broadcasting duration of the channel before turn-off the TV is stored by the storage module 904 in the record of the time period of 06:00-9:00.

In a similar way, it can be configured that the broadcasting duration of each channel are stored by the storage module only when a turn-off command is received. Therefore, when selecting channels or turning on the TV, the first list of recommended channels prompted can only be the first list of recommended channels of last time period. For the above example, CCTV channel has been broadcasted for 25 minutes on Wednesday and CETV for 30 minutes; the broadcasting duration this time will not be stored until the TV is turned off. Therefore, when selecting channels after having watched the two programs, the first list of recommended channels prompted by the prompting module 903 is the same with the first list of recommended channels being prompted in turning-on the TV. The first list of recommended channels will only be changed until the TV is turned on next time. The other technical features are the same with the above method.

### Embodiment 5

In the fifth embodiment, when a first user command is received such as the turn-on command or channel-selecting command, the first list of recommended channels and the second list of recommended channels are determined by storing, accumulating and ranking the historical broadcasting duration and times of each channel. The first list of recommended channels or the second list of recommended channels are then chosen to be prompted according to the prompting module. When a second user command is received such as the turn-off command or the switching-channel command, the broadcasting duration and times are stored.

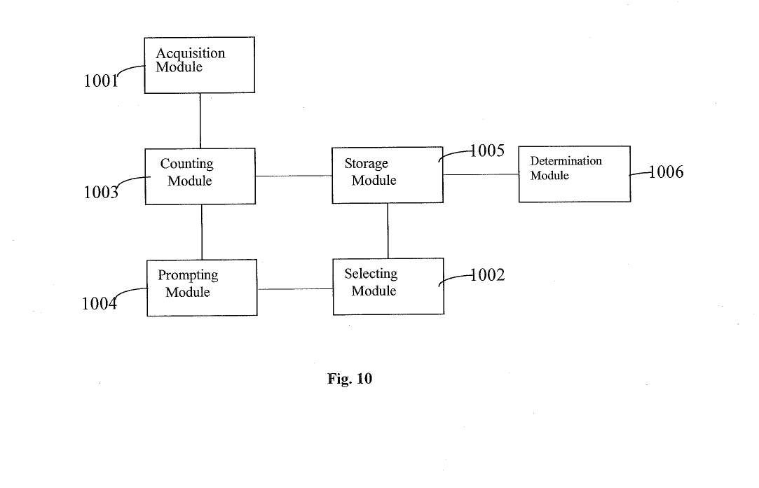

FIG. 10 is a flow chart the device for smart selection of TV channels according to the fourth embodiment of the present invention.

The device includes:

an acquisition module 1001, configured to obtain the current time upon the first user command, and to determine the preset time period based on the current time;

a selecting module 1002, configured to send to the prompting module 1004 the command of prompting the first list of recommended channels upon receiving the user command of prompting the first list of recommended channels; or to send to the prompting module 1004 the command of prompting the second list of recommended channels upon receiving the user command of prompting the second list of recommended channels;

a counting module 1003 connecting to the acquisition module 1001, configured to sum up the broadcasting duration of each channel and the historical broadcasting duration of each channel during the preset time period in accordance to the first user command, so as to obtain the accumulated broadcasting duration of each channel; and to rank the channels according to their accumulated broadcasting duration, the channel with longer accumulated broadcasting duration is ranked in front of the channel with shorter broadcasting duration, by which the first list of recommended channels is determined.

The counting module 1003 is further configured to sum up the number of times of broadcasting of each channel and the historical number of times of broadcasting of each channel during the preset time period in accordance to the first user command, so as to obtain the accumulated number of times of broadcasting of each channel; and to rank the channels according to their accumulated number of times of broadcasting, the channel with more number of times of broadcasting is ranked in front of the channel with less number of times of broadcasting, by which the second list of recommended channels is determined.

The device further includes a prompting module 1004 connecting to the selecting module 1002, configured to receive the command of prompting the first list of recommended channels from the selecting module, and to prompt the first list of recommended channels; or receiving the command of prompting the second list of recommended channels from the selecting module, and to prompt the second list of recommended channels; and

a storage module 1003 connecting to the counting module 1003, configured to store the broadcasting duration and times of each channel during the preset period according to the second user command.

The first user command may be a user turn-on command, a user channel-selecting command and a user checking command, while the second user command may include a user channel-switching command, a user turn-off command and a user presetting command. The user presetting command is a command provided according to the user's need. For example, the second user command is set to 10:00 pm, then the broadcasting duration of each channel during preset time period will be stored at 10:00 pm. However, the first user command and the second user command are not limited to the above-mentioned commands.

The preset time period can be set according to the user's need, and can be adjusted with different countries and districts. The present embodiment will be described with one of these ways.

For instance, the time periods can be set as the following:

time periods on working days: the first time period of 00:00-6:00, the second time period of 06:00-9:00, the third time period of 9:00-12:00, the fourth time period of 12:00-18:00, the fifth time period of 18:00-21:00, and the sixth time period of 21:00-24:00;

Time periods on non-working days: the seventh time period of 00:00-24:00.

By dividing into different time periods, different needs of family members, i.e. housewife, children and husband to watch TV in different time periods can be satisfied. For instance, the second time period may be for a housewife, and the fourth time period may by for children, and the fifth time period may be for a husband. On non-working days, everyone rests, thus the time periods are combined into one.

When the user turns on the TV, the current time is obtained by the acquisition module 1001, based on which the preset time period is determined, such as the second time period of 06:00-9:00. The user can choose whether to prompt the first list of recommended channels or to prompt the second list of recommended channels via the selecting module 1002. When the first list of recommended channels is chosen, the counting module 1003 will obtain the accumulated broadcasting duration of each channel by accumulating the historical broadcasting duration of each channel during the preset time period; channels are ranked according to their accumulated broadcasting duration, e.g. the channel with longer accumulated broadcasting duration is ranked in front of the channel with shorter accumulated broadcasting duration, based on which the first list of recommended channels is determined. Based on the determined first list of recommended channels, the first list of recommended channels is prompted by the prompting module 1004. When the second list of recommended channels is chosen, the counting module 1003 will obtain the accumulated number of times of broadcasting of each channel by accumulating the historical number of times of broadcasting of each channel during the preset time period; channels are ranked according to the accumulated number of times of broadcasting of each channel, the channel with more number of times of broadcasting is ranked in front of the channel with less number of times of broadcasting, based on which the second list of recommended channels is determined. Based on the determined second list of recommended channels, the second list of recommended channels is prompted by the prompting module 1004. The first list of recommended channels can be displayed directly, or can be notified by voice. The second list of recommended channels chosen to be prompted will be illustrated as an example in the following description.

The second list of recommended channels chosen to be prompted will be illustrated as an example in the following description.

The accumulated number of times of broadcasting of each channel is obtained via the counting model 1003 by accumulating the historical number of times of broadcasting of each channel during the historical time period of 06:00-9:00. For instance, before the TV is turned on, during the time period of 06:00-9:00, on Monday CCTV channel has been broadcasted for three times, with Guangdong TV channel two times; on Tuesday CCTV channel has been broadcasted for three times, with CETV channel four times. Thus, the accumulated number of times of broadcasting of each channel is that: six times for CCTV channel, two times for Guangdong TV channel and four times for CETV channel.

The accumulated historical broadcasting duration of each channel can be summed periodically according to the preset broadcasting duration by the counting model 1003. The preset time period can be one week, one month or a quarter of the year, which depends on the specific situation. For instance, the broadcasting duration of each channel may be obtained once a month and reset after one month, and then the next calculation starts again, by storing the broadcasting duration of each channel, to obtain the accumulated broadcasting duration of each channel. That is, the historical broadcasting duration to be accumulated is within the preset time period, which may be one week, one month or a quarter of the year, depending on the specific situation. For instance, the broadcasting duration of each channel may be obtained once a month, and when one month has passed, the broadcasting duration stored one month ago shall be cleared and new duration within the last one month is added, according to the principle of “first in, first out”.

Channels are ranked by the counting model 1003 according to the accumulated number of times of broadcasting, the channel with more number of times of broadcasting is ranked in front of the channel with less number of times of broadcasting, based on which the first list of recommended channels is obtained. For instance, the ranking may be that: CCTV channel, CETV channel, Guangdong TV channel. The amount of channels in the first recommended list is set upon different need, such as 5, 10 and 17, etc. After that the first list of recommended channels is prompted by the prompting module 1004. The first list of recommended channels can be displayed directly, or can be notified by voice.

When a channel-switching command is received, the number of times of broadcasting of the channel watched before switching channel is stored by the storage module 1005 in the record of the time period of 06:00-9:00.

When the command of channel-selecting is received, the current time is obtained by the acquisition module 1001, based on which the preset time period is determined, such as the second time period of 06:00-9:00. The counting module 1003 obtains the accumulated number of times of broadcasting of each channel by accumulating the historical number of times of broadcasting of each channel during the historical time period of 06:00-9:00. For instance, before the TV is turned on, during the time period of 06:00-9:00, on Monday CCTV channel has been broadcasted for three times, with Guangdong TV channel for two times; on Tuesday CCTV channel has been broadcasted for three times, with CETV channel for four times. Thus, the accumulated number of times of broadcasting of each channel is that: six times of CCTV channel, two times of Guangdong TV channel and four times of CETV channel. The channels are ranked based on the accumulated number of times of broadcasting of each channel, the channel with more number of times of broadcasting is ranked in front of the channel with less number of times of broadcasting, based on which the updated second first list of recommended channels is determined. For instance, the ranking may be that: CCTV channel, CETV channel, Guangdong TV channel. The amount of channels in the first recommended list is set upon different need, such as 5, 10 and 17, etc. After that the first list of recommended channels is prompted by the prompting module 1004. The first list of recommended channels can be displayed directly, or can be notified by voice.

When a turn-off command is received, similar to the channel-selecting command, the broadcasting duration of the channel watched before turn-off the TV is stored by the storage module 1005 in the record of the time period of 06:00-9:00. The option of prompting the second list of recommended channels is similar to that of the first list of recommended channels, which will not be illustrated in detail. Preferably, when turning on the TV or selecting channels, the selecting module 802 is also configured to allow the user to choose whether to prompt the first list of recommended channels or to prompt the second list of recommended channels; upon receiving the command of prompting the first list of recommended channels or the second list of recommended channels, then the page shows the first list of recommended channels or the second list of recommended channels, and the user can select channels according to the prompted first list of recommended channels or the second list of recommended channels.

In an embodiment, when turning on the TV or selecting channels, the selecting module 1002 is also configured to allow the user to choose whether to prompt the first list of recommended channels or to prompt the second list of recommended channels; upon receiving the command of prompting the first list of recommended channels or the second list of recommended channels, the page shows the first list of recommended channels or the second list of recommended channels, and the user can select channels according to the prompted first list of recommended channels or the second list of recommended channels.

In an embodiment, when turning on the TV or selecting channels, the selecting module 1002 is further configured to allow the user to choose whether to check the preset list of favorite channels. The list of favorite channels is set by the user himself based on the user's preference. If the answer is yes, then the list of favorite channels is prompted.

There is no fixed sequence for the selecting module 1002 in selecting to prompt the first list of recommended channels, the second list of recommended channels or the list of favorite channels, and can be set by the user himself based on the user's need. The first list of recommended channels, the second list of recommended channels and the list of favorite channels can be displayed directly, or can be notified by voice to the user.

In an embodiment, the selecting module 1002 is further configured to receive the user command of not to store the broadcasting duration and times of the channel and to send such command to the storage module 1005. When watching TV, the user can also chooses whether to store the broadcasting duration and times of the channel or not; and if the users chooses not to store, then the broadcasting duration of each channel will not be stored.

In an embodiment, the device further includes a determination module 1006, configured to determine whether there is any preset locked channel; if the answer is yes, then the determination module 1006 sends the command of not to store the broadcasting duration or times of the locked channel to the storage module 802. The user can set locked channels, such as some obscene channels, which can be locked by the user. The broadcasting duration and times of these channels will not be stored.

In a similar way, the storage module 1005 can be configured to store the broadcasting duration and times of each channel only when a turn-off command is received. As a result, when selecting channels or turning on the TV, the first list of recommended channels prompted by the prompting module 803 can only be the previous first list of recommended channels of the preset time period. For the above example, CCTV channel has been broadcasted for two times on Wednesday, with CETV channel for five times and Guangdong TV channel for three times; the number of number of times of broadcasting this time will not be stored until the TV is turned off. Therefore, when selecting channels after having watched the two programs, the first list of recommended channels prompted by the prompting module 1004 is the same with the first list of recommended channels being prompted in turning-on the TV. The first list of recommended channels will only be changed until the TV is turned on next time. The other technical features are the same with the above method.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for smart selection of TV channels, comprising:
receiving a first user command, obtaining current time, determining a preset time period based on the current time, and prompting a first list of recommended channels corresponding to the preset time period;
wherein determining the first list of recommended channels comprises: obtaining accumulated broadcasting duration of each channel by accumulating historical broadcasting duration of each channel during the preset time period; ranking the channels according to accumulated broadcasting duration of each channel, and the channel with longer accumulated broadcasting duration is ranked in front of the channel with shorter accumulated broadcasting duration, based on which the first list of recommended channels is determined.

2. The method of claim 1, wherein after prompting the first list of recommended channels corresponding to the preset time period, the method further comprises:
receiving a second user command, and storing the broadcasting duration of each channel during the preset time period.

3. The method of claim 1, wherein after prompting the first list of recommended channels corresponding to the preset time period, the method further comprises:
receiving a second user command, storing the broadcasting duration of each channel during the preset time period, and accumulating the broadcasting duration of each channel and the historical broadcasting duration of each channel during the preset time period, so as to obtain the accumulated broadcasting duration of each channel; ranking the channels according to the accumulated broadcasting duration of each channel, and the channel with longer accumulated broadcasting duration is ranked in front of the channel with shorter accumulated broadcasting duration, by which the first list of recommended channels is updated.

4. The method of claim 3, wherein after receiving the first user command and before prompting the first list of recommended channels corresponding to the preset time period, the method further comprises: receiving a user command of prompting the first list of recommended channels;
after receiving the first user command, the method further comprises: prompting the second list of recommended channels upon receiving a user command of prompting the second list of recommended channels;
after receiving the second user command, the method further comprises: storing the number of times of broadcasting of each channel during the preset time period, and accumulating the number of times of broadcasting of each channel and the historical number of times of broadcasting of each channel during the preset time period, so as to obtain the accumulated number of times of broadcasting of each channel; ranking the channels according to the accumulated number of times of broadcasting of each channel, and the channel with more number of times of broadcasting is ranked in front of the channel with less number of times of broadcasting, by which the second list of recommended channels is updated.

5. The method of claim 1, wherein after receiving the first user command and before prompting the first list of recommended channels corresponding to the preset time period, the method further comprises:
accumulating the historical broadcasting duration of each channel during the preset time period, so as to obtain the accumulated broadcasting duration of each channel; ranking the channels according to the accumulated broadcasting duration of each channel, the channel with longer broadcasting duration is ranked in front of the channel with shorter broadcasting duration, by which the first list of recommended channels is determined;
wherein after prompting the first list of recommended channels corresponding to the preset time period, the method further comprises:
receiving the second user command, storing the broadcasting duration of each channel during the preset time period.

6. The method of claim 5, wherein after receiving the first user command and before accumulating the historical broadcasting duration of each channel, the method further comprises:
receiving the user command of prompting the first list of recommended channels;
after receiving the first user command, the method further comprises:
upon receiving the user command of prompting the second list of recommended channels, accumulating the historical number of times of broadcasting of each channel during the preset time period, so as to obtain the accumulated number of times of broadcasting of each channel; ranking the channels according to the accumulated number of times of broadcasting of each channel, the channel with more number of times of broadcasting is ranked in front of the channel with less number of times of broadcasting, by which the second list of recommended channels is determined, and prompt the second list of recommended channels;
after receiving the second user command, the method further comprises: storing the number of times of broadcasting of each channel during the preset time period.

7. The method of claim 2, wherein the first user command is a user turn-on command, a user channel-selecting command or a user checking command, while the second user command is a user channel-switching command, a user turn-off command, or a user presetting command.

8. The method according to claim 2, wherein after receiving the first user command and before prompting the first list of recommended channels corresponding to the preset time period, the method further comprises:
displaying the information of whether to prompt the first list of recommended channels, and receiving the user command of prompting the first list of recommended channels, and/or
displaying the information of whether to prompt the list of favorite channels, receiving the user command of prompting the preset list of favorite channels, and prompting the list of favorite channels.

9. The method according to claim 2, wherein before storing the broadcasting duration of each channel in the preset time period, the method further comprises:
determining whether there is any preset locked channel; if yes, then the broadcasting duration of the locked channel is not stored; and/or
displaying the information of whether to store the channel, and to receive the user command of storing the channels.

10. The method according to claim 2, wherein the prompting comprises displaying and voice notifying.

11. The method according to claim 2, wherein the time period comprises:
time periods on working days: a first time period of 00:00-6:00, a second time period of 06:00-9:00, a third time period of 9:00-12:00, a fourth time period of 12:00-18:00, a fifth time period of 18:00-21:00, and a sixth time period of 21:00-24:00; and
time periods on non-working days: a seventh time period of 00:00-24:00.

12. A device for smart selection of TV channels, comprising:
an acquisition module, configured to obtain the current time upon the first user command, and to determine the preset time period based on the current time;
a prompting module, configured to prompt the first list of recommended channels corresponding to the preset time period upon receiving the first user command; determining the first list of recommended channels comprises: obtaining the accumulated broadcasting duration of each channel by accumulating the historical broadcasting duration of each channel during the preset time period; ranking the channels according to the accumulated broadcasting duration, the channel with longer accumulated broadcasting duration is ranked in front of the channel with shorter accumulated broadcasting duration, based on which the first list of recommended channels is determined.

13. The device of claim 12, wherein the device further comprises:
a storage module, configured to store the broadcasting duration of each channel during the preset time period.

14. The device of claim 13, wherein the device further comprises:
a counting module, configured to accumulate the broadcasting duration of each channel and the historical broadcasting duration of each channel during the preset time period, so as to obtain the accumulated broadcasting duration of each channel, and to rank the channels according to the accumulated broadcasting duration of each channel, the channel with longer accumulated broadcasting duration being ranked in front of the channel with shorter broadcasting duration, by which the first list of recommended channels is updated.

15. The device of claim 14, further comprising:
a selecting module, configured to send to the prompting module the command of prompting the first list of recommended channels upon receiving the user command of prompting the first list of recommended channels; and to send to the prompting module the command of prompting the second list of recommended channels upon receiving the user command of prompting the second list of recommended channels;
wherein the prompting module is further configured to receive the command of prompting the first list of recommended channels from the selecting module and to prompt the first list of recommended channels; and to receive the command of prompting the second list of recommended channels from the selecting module and to prompt the second list of recommended channels;
the storage module is further configured to store the number of times of broadcasting of each channel during the preset time period upon receiving the second user command;
the counting module is further configured to accumulate the number of times of broadcasting of each channel and the historical number of times of broadcasting of each channel during the preset time period upon receiving the second user command, so as to obtain the accumulated number of times of broadcasting of each channel; and to rank the channels according to the accumulated number of times of broadcasting, the channel with more accumulated number of times of broadcasting being ranked in front of the channel with less number of times of broadcasting, by which the second list of recommended channels is updated.

16. The device of claim 13, further comprising:
a counting module, configured to accumulate the historical broadcasting duration of each channel during the preset time period upon receiving the first user command, so as to obtain the accumulated broadcasting duration of each channel; and to rank the channels according to the accumulated broadcasting duration, the channel with longer accumulated broadcasting duration being ranked in front of the channel with shorter accumulated broadcasting duration, by which the first list of recommended channels is determined.

17. The device of claim 16, further comprising:
a selecting module, configured to send to the prompting module the command of prompting the first list of recommended channels upon receiving the user command of prompting the first list of recommended channels; or to send to the prompting module the command of prompting the second list of recommended channels upon receiving the user command of prompting the second list of recommended channels;
wherein the prompting module is further configured to receive the command of prompting the first list of recommended channels from the selecting module and to prompt the first list of recommended channels; or to receive the command of prompting the second list of recommended channels from the selecting module and to prompt the second list of recommended channels;
the storage module is further configured to store the number of times of broadcasting of each channel during the preset time period upon receiving the second user command;
the counting module is further configured to sum up the historical number of times of broadcasting of each channel during the preset time period upon receiving the first user command, so as to obtain the accumulated number of times of broadcasting of each channel; and to rank the channels according to their accumulated number of times of broadcasting, the channel with more number of times of broadcasting being ranked in front of the channel with less number of times of broadcasting, by which the second list of recommended channels is updated.

18. The device according to claim 13, wherein the first user command is a user turn-on command, a user channel-selecting command or a user checking command, while the second user command is a user channel-switching command, a user turn-off command or a user presetting command.

19. The device of claim 15, wherein the selecting module is further configured to receive the user command of checking the preset list of favorite channels, and to send the command of checking the preset list of favorite channels to the prompting module;
the prompting module is further configured to prompt the list of favorite channels; and/or
the selecting module is further configured to receive the command of storing the duration or number of times of broadcasting the channel and to send the command of storing the duration or times of broadcasting the channel to the counting module.

20. The device of claim 15, further comprising:
a determination module, configured to determine whether there is any preset locked channel; if there is, the determination module sends a command of not to store the duration or number of times of broadcasting the locked channel to the storage module.
